(19) United States
(12) Patent Application Publication
(10) Pub. No.: US 2008/0230957 A1
(43) Pub. Date: Sep. 25, 2008

(54) Device for Transforming Materials Using Induction Heating

(75) Inventors: Jose Feigenblum, Grenoble (FR); Alexandre Guichard, La Chapelle du Mont du Chat (FR)

Correspondence Address: RATNERPRESTIA, P O BOX 980, VALLEY FORGE, PA, 19482-0980, US

(73) Assignee: ROCTOOL, Le Bourget du Lac (FR)

(21) Appl. No.: 12/064,885

(22) PCT Filed: Jul. 7, 2006
(86) PCT No.: PCT/FR2006/050689

§ 371 Date: Feb. 26, 2008

(30) Foreign Application Priority Data
Sep. 12, 2005 (FR) 0509280

(51) Int. Cl. B29C 33/56; H05B 6/14; B29C 35/08; H05B 6/02

(52) U.S. Cl. 264/401; 425/3

(57) ABSTRACT

A device for transforming thermoplastic matrix composite materials or thermosetting materials, includes two mold casings that are mobile relative to each other, electrically conductive, and include a molding zone designed to be in contact with the material to be transformed. The faces of one of the two mold casings are situated so as to be facing magnetic field generator, except for the molding zones, and are coated with a shielding layer made of a non-magnetic material preventing the magnetic field from penetrating into the mold casings. The mold casings are electrically insulated from each other during the molding phase so that the faces of the two mold casings demarcate an air gap wherein flows the magnetic field that induces currents at the surface of the molding zones thus localizing the heating at the interface between the molding zone and the material to be transformed.

The present invention relates to a device and method using induction heating, especially with the aim of transforming or molding materials, especially thermoplastic matrix composite materials or thermosetting materials.

To achieve the molding of plastics parts or composite parts, prior art induction heating methods have the drawback of heating a major part of a mold casing

The invention limits induction heating to a surface, in order to localize the heating at the mold/material interface, thus limiting energy consumption and therefore improving the energy efficiency of the device. The productivity is also increased with reduced heating and cooling times because a very small fraction of the volume of the mold is subjected to induction heating.

The invention is also aimed at reducing the cost of tooling.

The invention thus relates to a device for the transformation, especially by molding, of materials, especially thermoplastic matrix composite materials or thermosetting materials, comprising:
two mold casings that are mobile relative to each other, made out of electrically conductive material, each including a molding zone designed to be in contact with the material to be transformed, and
induction means for generating a magnetic field with a frequency F enveloping the casing of the mold,
the faces of at least one of the two mold casings situated so as to be facing induction means, except for the molding zones, being coated with a shielding layer made of a non-magnetic material preventing the magnetic field from penetrating into the mold casings,

the mold casings being electrically insulated from each other during the molding phase so that the faces of the two mold casings demarcate an air gap wherein flows the magnetic field that induces currents at the surface of the molding zone of each mold casing, thus localizing the heating at the interface between the molding zone and the material to be transformed.

According to one embodiment, the two mold casings are coated with a shielding layer.

According to one embodiment, the mold casings comprise a magnetic compound, preferably having high relative magnetic permeability and resistivity, for example a nickel-based, chrome-based and/or titanium-based steel.

According to one embodiment, only one mold casing is coated with a shielding layer, the other mold casing comprising a non-magnetic material, preferably with low resistivity, for example aluminum.

According to one embodiment, the mold casing coated with a shielding layer comprises a magnetic compound, preferably having high relative magnetic permeability and resistivity, for example a nickel-based, chrome-based and/or titanium-based steel.

According to one embodiment, the shielding layer also overlaps a part, not constituting a molding zone, of at least one of the two mutually facing faces of the two mold casings.

According to one embodiment, the shielding zone also comprises a metal sheet fixed to the magnetic mold casing, this metal sheet being for example soldered or screwed in.

According to one embodiment, the shielding layer comprises a deposit of material, especially an electrolytic deposit.

According to one embodiment, the thickness e of the shielding layer is at least equal to:

e=50*(ρ/F)^{1/2}

ρ being the resistivity of the non-magnetic material, and F the frequency of the magnetic field.

According to one embodiment, the frequency F is at least equal to 25 KHz and preferably at most equal to 100 KHz.

According to one embodiment, the shielding layer comprises a non-magnetic material of low electrical resistivity, for example copper or aluminum.

According to one embodiment, an electrically insulating layer is applied to the molding zone of at least one mold casing to perfect the electrical insulation of these casings, especially when the material to be transformed is conductive.

According to one embodiment, the inductive means comprise two parts, each one fixedly joined to one of the mold casings to enable the opening of a device, and being capable of being shifted with the respective mold casing.

According to one embodiment, the two parts of the inductive means are electrically connected by means of at least one electrical contactor enabling contact to be maintained during the relative shift of one mold casing relative to the other one during the transformation phase.

The invention also relates to a method for the manufacture of parts, especially in large batches, making use of the device defined here above.

Other features and advantages of the invention shall appear from the following description, made by way of a non-restrictive example with reference to the appended drawings, of which:

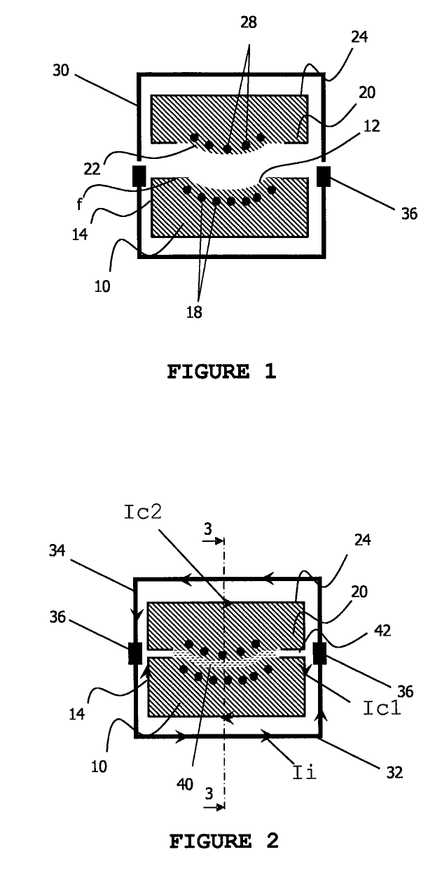

FIG. 1 shows a device according to the invention,

FIG. 2 shows the device of FIG. 1 during the transformation of a material,

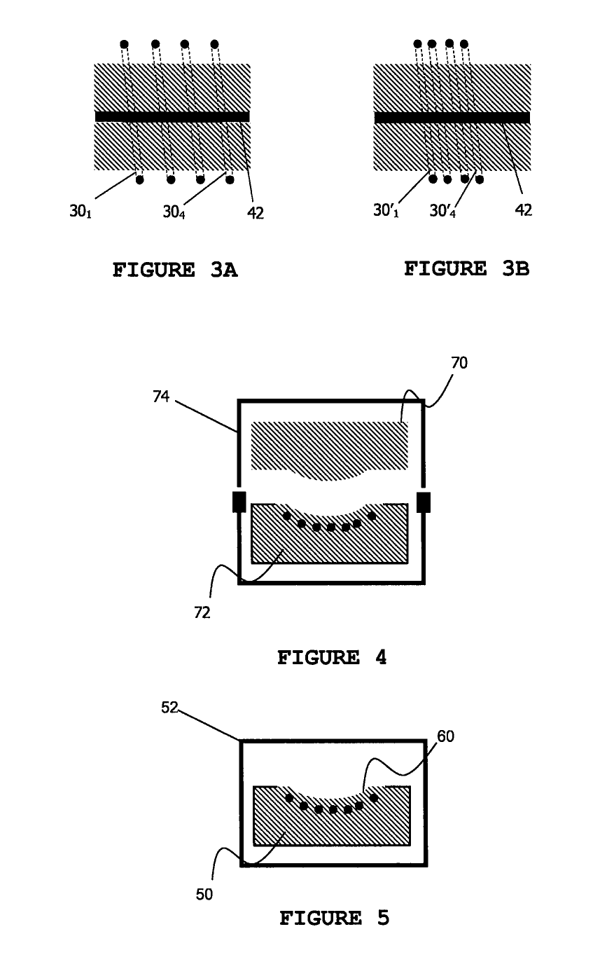

FIGS. 3a and 3b show two different arrangements of inductors for the device shown in FIG. 1, these figures corresponding to views along the line 3-3 of FIG. 2,

FIG. 4 shows a variant of the device, and

FIG. 5 shows a second variant.

The molding device shown in FIGS. 1 and 2 comprises two mold casings 10 and 20 moving relative to each other. The mold casings 10, 20 are made up out of a magnetic material, one part of which constitutes a molding zone, respectively 12 for the mold casing 10 and 22 for the mold casing 20. The molding zones 12, 22 are situated on two mutually facing faces of the mold casings.

A network of inductors 30, electrically connected in parallel or in series to a current generator, is positioned about the mold casings. Each inductor 30 comprises a conductive turn and comprises two separable parts 32, 34, each one being fixedly joined to a mold casing, 10, 20 respectively.

One part of the external surface of each mold casing 10, 20, except for the molding zones 12, 22, is lined with a shielding layer 14, 24. In the example, the shielding coats the external faces of the mold casings situated so as to be facing the inductors 30 and one part of the mutually facing faces of the two mold casings. However, it is not necessary for the external faces of the mold casings that are not facing an inductor (i.e. the faces parallel to the plane of FIG. 1) to be coated with a shielding layer because the magnetic field generated has very limited influence on these faces.

FIG. 1 shows the two mold casings at a distance from each other before molding and FIG. 2 is similar to that of FIG. 1 and shows the two mold casings during the molding operation.

During the transformation of a material 40, as shown in FIG. 2, this material is gripped and held under pressure between the molding zones 12, 22 of the two mold casings. The material then provides the electrical insulation between these two mold casings 10, 20. Through this electrical insulation, the space demarcated by the facing surfaces of the two mold casings constitutes an air gap 42 enabling the circulation of a magnetic field in this space.

When the inductor means comprising conductive turns 30 are crossed by alternating electrical currents Ii with a frequency F, for example ranging from 25 to 100 KHz, the inductors generate a magnetic field that envelops the mold casings 10, 20.

The magnetic field thus generated crosses the mold casings and also circulates in the air gap, i.e. between the mold casings.

The magnetic field induces currents in directions opposite to the directions of the currents Ii and the presence of the air gap enables the generation of the induced currents Ic1 and Ic2 which flow on the surface of each of the two mold casings.

The shielding layer prevents the magnetic field from reaching the mold casing, except for the molding zones. These induced current Ic1 and Ic2 therefore have thermal action chiefly on the surface of the molding zone which is therefore the main zone heated by the action of the inductors. Since the shielding is non-magnetic, it is very little heated by induction.

In order that the device may work efficiently, the shielding layer must have a thickness greater than the penetration depth of the magnetic field (skin thickness). Thus, the magnetic field is prevented from reaching the mold casing and heating it in places other than the molding zone.

To determine the thickness of the shielding layer required, the following formula is used:

e=50*(ρ/F·μr)^{1/2}

where ρ is the resistivity of a non-magnetic field, μr is the relative magnetic permeability of the material, and F the frequency of induction currents. For a non-magnetic material, we take: μr=1, and the formula becomes: e=50*(ρ/F)^{1/2} In order that the magnetic shielding may be effective, the thickness of the layer of non-magnetic material must be greater than the skin thickness with the frequency mentioned here above, ranging from 25 KHz to 100 KHz, the skin thicknesses are less than one millimeter.

The device of the invention is especially efficient as the presence of the air gap 42 has the effect of concentrating the magnetic flow within it, thus further increasing the action of the magnetic field at the molding zones and hence the inductive energy contributed to the surface of the molding zones.

One device according to the invention therefore has the advantage of locally heating the molding zone, directly at the molding zone/material interface and not in the thickness of the mold casing. This amounts to a substantial saving of energy. A device of this kind also has the advantage of being simple and costing little to manufacture.

The air gap also has the effect of limiting the influence of the geometry and/or the distribution of the inductors on the resultant heating because the air gap 42 (FIGS. 3a and 3b) “smoothens” the energy provided by the inductors. Thus, inductive turns 30′₁ to 30′₄ (FIG. 3b) evenly distributed on the length of the mold have practically the same effect as the same number of inductor turns 30₁ to 30₄ (FIG. 3a) distributed on a shorter length. This arrangement makes it possible to choose the distribution of the inductive turns at will.

The fixing of the layer of non-magnetic material on the mold casing may be done in various ways, for example by fixing a sheet metal or by depositing material, for example by an electrolytic deposition.

The non-magnetic material used to form the shielding preferably has low resistivity so as to limit energy losses. The material is, for example, copper or aluminum.

The magnetic material used for the mold casing is a magnetic compound which may have a Curie temperature as well as an electrical resistivity that is greater than that of copper, as is the case for example with nickel-based, chrome-based and/or titanium-based steel alloys. High electrical resistivity of the mold casing is an advantage because it enables more efficient induction heating. However, it must be noted that the magnetic permeability of the material constituting the mold casing also influences the efficiency of the induction heating. Indeed, if we refer to the formula mentioned here further above, high relative magnetic permeability leads to a lower penetration depth of the magnetic field, and a same quantity of energy is therefore distributed on a more restricted zone and the result thereof is greater heating.

When the material has a Curie point, at a temperature close to this Curie point the material of the mold casing loses its magnetic properties and the induction heating diminishes greatly, thus enabling the heating temperature to be regulated around the Curie point.

The device shown in FIGS. 1 and 2 is provided with a cooling system to enable the making or transformation of parts by heating at a high rate, the cooling being implemented between two processing operations. To this end, in each mold casing, there is provided a network of channels 18, 28 enabling a cooling liquid to be made to flow in the vicinity of the molding surfaces 12, 22. The cooling thus obtained performs very well firstly because the metal mold casing is thermally highly conductive and secondly because the channels may be laid out as closely as possible to the molding zones 12, 22.

In the case of the molding of a composite material, after the heating and shaping cycle, the cooling is used to fix the composite material in its definitive form.

Unlike known systems, the device of the invention concentrates the action of the magnetic field and the thermal effects in the vicinity of the molding zones. As a consequence, since the heating is more localized, there is less thermal energy to be dissipated during the cooling which is therefore faster. Thus, the cycle time of the device is reduced and the productivity is therefore significantly increased.

FIG. 1 identifies the boundary f between each mold casing 10, 20 and the layer of non-magnetic material that lines it. The position of this boundary f relative to the molding zone 12, 22 has an influence on the quality of the heating and hence on the molding. With the device of the invention, it is easy, by adding or removing material, to modify the position of the boundary f, thus providing great flexibility in the designing of the tooling. Indeed, it becomes possible to adjust the position of the boundary after the processing tests, especially molding, in real conditions.

Since the inductors are made up of two separable parts 32, 34 fixedly joined to the mold, the separation of the two mold casings is easy. This enables fast extraction of the part 40 after molding and therefore contributes to manufacturing at a high rate. During the transformation of a material, the electrical continuity between the two parts 32, 34 of the network of inductors is ensured by electrical contactors 36. This contactor permits a relative shift of the two parts 32, 34 of the network of inductors because the transformation of the materials is generally done at constant pressure but leads to a reduction of thickness of the material and therefore a reduction of the distance between the two mold casings 10, 20.

The transformation of the electrically conductive composite materials necessitates the use of a variant of the device. Indeed, with conductor materials such as for example carbon-fiber-based materials, the electrical insulation between the two mold casings is not always perfectly ensured and short circuits may occur locally, generating electrical arcs that may affect the surface of the material to be transformed and/or the surface of the molding zones. To improve the electrical insulation and thus prevent any risk of shorting, an electrical insulating layer is deposited on at least one of the two molding zones 12, 22. Such a layer comprises for example Teflon, amorphous carbon, glass fiber or again ceramic-based materials. This layer must have temperature worthiness and adapted mechanical resistance with a thickness of about one micrometer.

Conventionally, mechanical means (not shown) for ejecting the manufactured part are also planned.

The manufacturing method thus implemented therefore comprises chiefly four phases:
positioning of the material or materials of the part to be processed on the lower mold casing of a device,
heating of the two molding zones, and pressurizing of the material between the two molding zones for a given period of time,
implementing the cooling of the mold casing in order to cool the parts;
raising the upper mold casing and ejecting/removing the part.

The method thus implemented benefits extensively from the advantages provided by the device according to the invention, especially in terms of productivity: the local heating related to the molding zone minimizes the cycle times.

The easy adjustment of the heated zone by the adding or removal of portions of the shielding layer provides great flexibility: it is easy to modify the tooling as a function of the results obtained during the first tests.

Finally, the tooling is economical to produce because the shielding layer 14, 24 does not necessitate any complex or costly manufacture.

One variant shown in FIG. 4 of the device according to the invention makes it possible to obtain a simpler tooling, especially in the context of the transformation of very fine parts, especially parts with a thickness of less than a millimeter. Indeed, such thicknesses are used to limit the heating to only one face of the part. The invention uses a device in which one of the two mold casings is not lined with a shielding layer, this mold casing (70) comprising a non-magnetic material. Thus, this mold casing (70), which is not transparent to the magnetic field, always make available an air gap wherein there flows the magnetic field created by the induction network (74). The induction heating is therefore done chiefly at the molding zone of the mold casing 72 which is coated with a shielding layer. Such a device is less costly to make because the mold casing (70) does not include any shielding layer. In the example of FIG. 4, the mold casing 70 is devoid of any cooling circuit.

Another variant (FIG. 5) provides for only one mold casing 50 around which inductive turns 52 are arranged. In this configuration, the shielding layer that surrounds the mold casing localizes the heating on the molding zone 60 without any presence of an air gap. The absence of this air gap makes such a device more sensitive to the geometry of the network of inductors, but the heating is chiefly localized on the surface of the molding zone through the shielding layer.

1. Device for the transformation, by heating, of thermoplastic matrix composite materials or thermosetting materials, comprising:
two mold casings that are mobile relative to each other, made out of electrically conductive material and including a molding zone designed to be in contact with the material to be transformed, and
induction means for generating a magnetic field with a frequency F enveloping the casing of the mold,
the faces of at least one of the two mold casings situated so as to be facing the induction means, except for the molding zones, being coated with a shielding layer made of a non-magnetic material preventing the magnetic field from penetrating into the mold casings,
the mold casings being electrically insulated from each other during the molding phase so that the faces of the two mold casings demarcate an air gap wherein flows the magnetic field that induces currents at the surface of the molding zone of each mold casing, thus localizing the heating at the interface between the molding zone and the material to be transformed.

2. Device according to claim 1, wherein the two mold casings are coated with the shielding layer.

3. Device according to claim 2, wherein the mold casings comprise a magnetic compound, preferably having high relative magnetic permeability and resistivity.

4. Device according to claim 1, wherein only one mold casing is coated with a shielding layer, the other mold casing comprising a non-magnetic material, preferably with low resistivity.

5. Device according to claim 4, wherein the mold casing coated with the shielding layer comprises a magnetic compound, preferably having high relative magnetic permeability and resistivity.

6. Device according to one of the claims 1 to 5, wherein the shielding layer also overlaps a part, not constituting a molding zone, of at least one of the two mutually facing faces of the two mold casings.

7. Device according to one of the claims 1 to 5, wherein the shielding zone also comprises a metal sheet fixed to the magnetic mold casing.

8. Device according to one of the claims 1 to 5, wherein the shielding layer comprises an electrolytic deposit of material.

9. Device according to one of the claims 1-5, wherein the thickness e of the shielding layer is at least equal to:
e=50*(ρ/F)^{1/2}
ρ being the resistivity of the non-magnetic material, and F the frequency of the magnetic field.

10. Device according to one of the claims 1-5, wherein the frequency F is at least equal to 25 KHz and at most equal to 100 KHz.

11. Device according to one of the claims 1-5, wherein the shielding layer comprises a non-magnetic material of relatively low electrical resistivity.

12. Device according to one of the claims 1-5, wherein an electrically insulating layer is applied to the molding zone of at least one mold casing to improve the electrical insulation between the mold casings.

13. Device according to one of the claims 1-5, wherein the inductive means comprise two parts, each one fixedly joined to one of the mold casings, and being shifted with the respective mold casing.

14. Device according to claim 13, wherein the two parts of the inductive means are electrically connected by means of at least one electrical contactor enabling which causes contact to be maintained during the relative shift of one mold casing relative to the other one during the transformation phase.

15. Method for the manufacture of parts in large batches making use of a device according to one of the claims 1-5, and comprising the following steps:
positioning the material or materials of the part to be processed on the lower mold casing of the device,
heating the two molding zones, and pressurizing the material between the two molding zones for a given period of time
